(19) United States
(12) Patent Application Publication
(10) Pub. No.: US 2006/0094399 A1
(43) Pub. Date: May 4, 2006

(54) Asset security system application using mobile station having an integrated transponder reader

(76) Inventor: Pierre B. Dupont, Slocan (CA)

Correspondence Address: MOTOROLA INC, 600 NORTH US HIGHWAY 45, ROOM AS437, LIBERTYVILLE, IL, 60048-5343, US

(21) Appl. No.: 10/976,747

(22) Filed: Oct. 29, 2004

(51) Int. Cl. H04M 3/16

(52) U.S. Cl. 455/410

(57) ABSTRACT

A method of operating a mobile station (301) is provided in which the mobile station (301) may receive data from transponders corresponding to a set of items such as a brief case (305), wallet (307) and suit case (309). The mobile station (301) may then compare the transponder data to a list of items (317) stored in memory and determine whether an identifier has been received for each item in the list. The mobile station (301) may provide an indication to the mobile station (301) user if an identifier has not been received for each item in the list, and may also transmit a second indication to a security server (311) via a wireless network (313).

### FIELD OF THE INVENTION

The present invention relates generally to wireless networks, and more particularly to mobile stations, transponder readers, and to the field of physical browsing.

### BACKGROUND OF THE INVENTION

Communication networks such as GSM and GPRS, WCDMA, EDGE and various wireless local area network (WLAN) technologies such as 802.11 and Bluetooth™ enable Internet and intranet connectivity of mobile stations as well as Internet browsing. Therefore, most mobile stations may access various networks in which each of the various networks may provide coverage for a particular geography based upon the radio propagation coverage of the network.

Transponder systems such as RFID have become widespread because of their usefulness for information collection and tracking and many applications have emerged. For example, livestock may be labeled and tracked by tags for the purpose of preventing diseased animals, or groups of animals, from entering into food production. In addition, retail stores may tag items for the purpose of performing quick inventory by simply scanning the shelved or warehoused items. Theft prevention of items is another popular application of transponder tags in the retail store business. Most such transponder applications are commercial applications and have no direct benefits for private individuals.

Transponder systems such as Radio Frequency Identification (RFID) systems use radio technology to remotely read data from a transponder, known as an RF tag or simply a tag. An transponder system generally comprises an transponder reader, a reader antenna, and a tag which also comprises a tag antenna. An transponder reader is sometimes combined with a decoder and is referred to as an interrogator.

Transponder systems are generally of two types, inductively coupled and propagation coupled. An inductively coupled system requires that the tag come within a close proximity of the transponder reader. Propagation coupled systems allow reading of tags from greater distances by transmitting radio waves from the reader and receiving a signal back from a tag. Additionally, tags may be active or passive, which is a factor in the size and weight of the tag. Passive tags can be extremely small in size and weight and are therefore ideal for certain applications such as theft detection in retail stores, because such tags can be easily concealed within a product's packaging and detected by a receiving antenna positioned near a store exit.

If the beneficial aspects of transponder data collection systems could be made use of for mobile station communication, private individuals may be able to benefit more directly from the technology. In particular, theft detection systems could be made personal to mobile station users such that personal items could be more secure in public areas where wireless network coverage is available.

Therefore a need exists for a method and apparatus which combines the wireless network access capabilities of a mobile station with the data access capabilities of an transponder system to create a personal theft detection system. The method and apparatus would ideally integrate transponder capabilities with mobile station technology such that a mobile station user may benefit from various security networks.

### BRIEF DESCRIPTION OF THE DRAWINGS

FIG. 1 is a block diagram illustrating a network infrastructure in which a mobile station may operate in accordance with embodiments of the present invention.

FIG. 2 is a block diagram illustrating the primary components of a mobile station in accordance with some embodiments of the present invention.

FIG. 3 is a block diagram illustrating a personal alarm system in accordance with an embodiment of the present invention.

FIG. 4 is a block diagram illustrating an exemplary menu format of some embodiments of the present invention.

FIG. 5 is a flow diagram illustrating an initial configuration operation of embodiments of the present invention.

FIG. 6 is a flow diagram illustrating the basic operation of embodiments of the present invention.

FIG. 7 is a block diagram of transponder tag information bit fields in accordance with some embodiments of the present invention.

### DETAILED DESCRIPTION OF THE PREFERRED EMBODIMENTS

To address the above-mentioned need, an apparatus and method for enabling an asset security system, that may be used as a personal security system, is provided herein.

In accordance with the present invention, a mobile station comprises an transponder interrogator and an alarm application. A set of items will have transponder tags that have either been installed by the item manufacturers, or installed strategically within the item by the item owner. The mobile station may initially interrogate the tags and associate each of the items with its corresponding tag data. Additional descriptive information may be added to the mobile station memory by the user. The mobile station will then periodically scan for tag data and compare it to the data stored in memory. If one of the items is not detected, indicating a potential theft, the mobile station will alert the mobile station user and in some embodiments will inform a security server of the missing item or items.

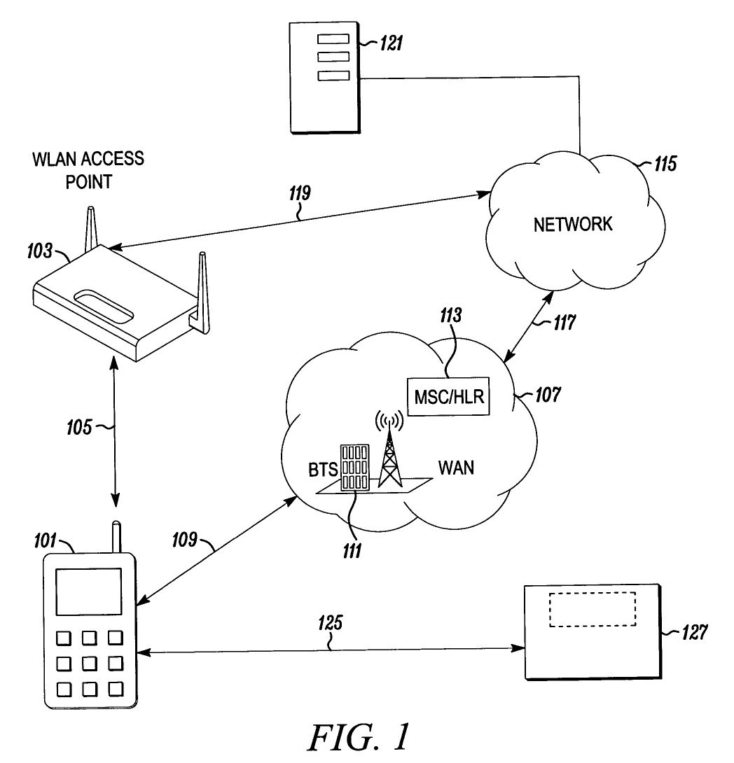

Turning now to the drawings wherein like numerals represent like components, FIG. 1 is a block diagram illustrating a network infrastructure in which a mobile station may operate in accordance with embodiments of the present invention. In FIG. 1, mobile station 101 is capable of communicating with a Wireless Local Area Network (WLAN) via WLAN Access point (AP) 103 and WLAN air interface 105 which may be 802.11, Bluetooth™, IrDA, HomeRF, etc. Mobile station 101 communicates with a cellular network 107 via cellular air interface 109 which may be GSM, CDMA, CDMA2000, UMTS, etc.

The cellular network 107 is a wide area network (WAN) and comprises various components such as Base Transceiver Station (BTS) 111 and Mobile Switching Center (MSC) 113 which also comprises a Home Location Register (HLR).

It is to be understood that the WAN 107 as shown in FIG. 1 is for illustrative purposes only, and that the WAN will comprise a number of BTSs, MSCs, HLRs, as well as other components not specifically mentioned herein.

The WAN 107 may also communicate with other networks such as network 115, which may be the Internet, via connection 117 which may make use of any suitable connection means. Similarly, the WLAN network, or AP 103 may communicate with network 115 via connection 119, which may make use of any suitable connection means including, but not limited to; a leased telephone line, T1, E1, infra-red, or a radio frequency point-to-point connection. The network 115 may comprise a number of smaller networks or servers such as transponder security server 121.

The mobile station 101 comprises an transponder interrogator component which can transmit and receive signals over an air interface 125, to read data from a transponder tag 127. After reading the information provided by tag 127, the mobile station 101 may transmit the information to transponder security server 121 via the WLAN AP 103 or WAN 107.

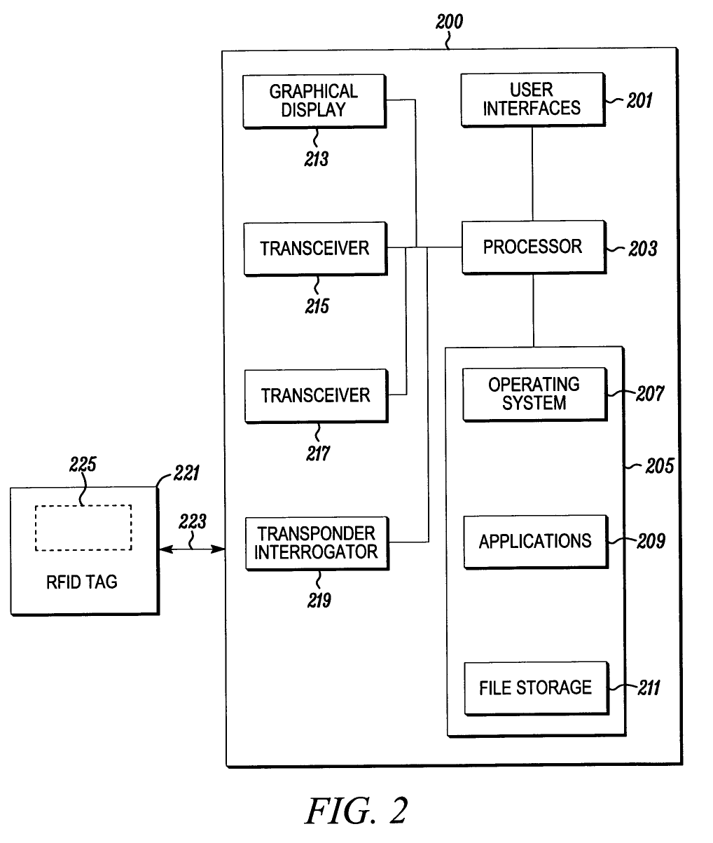

FIG. 2 is a block diagram illustrating the primary components of a mobile station in accordance with some embodiments of the present invention. Mobile station 200 comprises user interfaces 201, at least one processor 203, and a memory 205. Memory 205 has storage sufficient for the mobile station operating system 207, applications 209 and general file storage 211. Mobile station 200 user interfaces 201, may be a combination of user interfaces including but not limited to a keypad, touch screen, voice activated command input, and gyroscopic cursor controls.

Mobile station 200 has a graphical display 213, which may also have a dedicated processor and/or memory, drivers etc. which are not shown in FIG. 2. It is to be understood that FIG. 2 is for illustrative purposes only and is for illustrating the main components of a mobile station in accordance with the present invention, and is not intended to be a complete schematic diagram of the various components required for a mobile station. Therefore, a mobile station may comprise various other components not shown in FIG. 2 and still be within the scope of the present invention.

Returning to FIG. 2, the mobile station 200 also comprises a number of transceivers such as transceivers 215 and 217. Transceivers 215 and 217 may be for communicating with various wireless networks such as WLAN AP 103 and WAN 107 using for example 802.11 and GSM, respectively.

In addition to the transceivers 215 and 217, mobile station 200 comprises an additional wireless capability, specifically transponder interrogator 219, for communicating with transponder tag 221 using air interface 223. The transponder tag 221 comprises and internal antenna 225, and the transponder interrogator 219 likewise has an internal antenna although this antenna is not explicitly illustrated in FIG. 2. A user may activate the mobile station 200 transponder interrogator 219 by activating, for example, a button which is part of the user interfaces 201. Any suitable user activation of transponder interrogator 219 may be used and would still remain within the scope of the present invention.

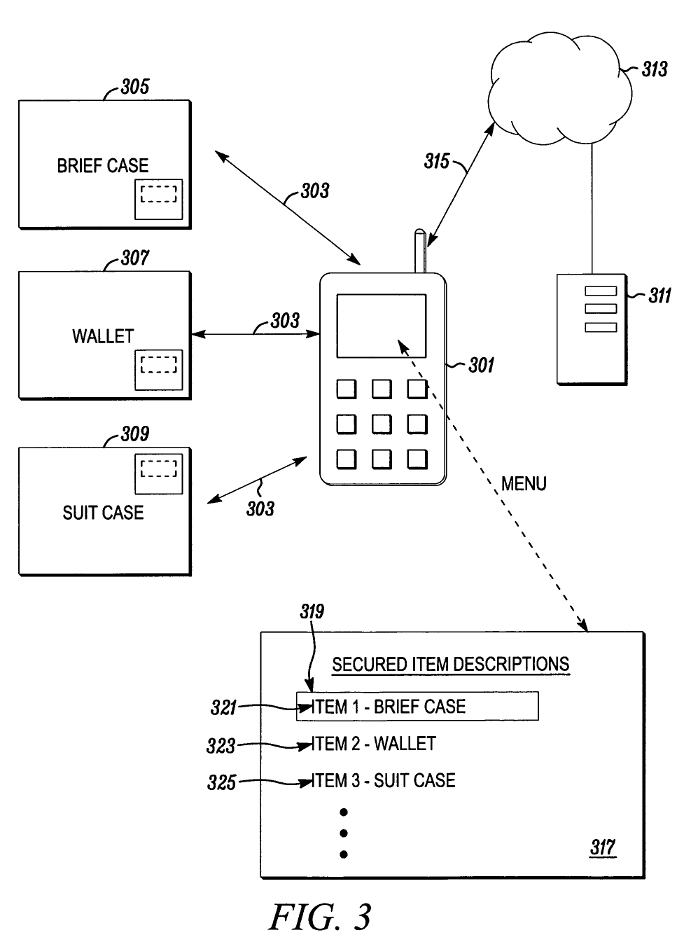

FIG. 3 illustrates an embodiment of the present invention in which a mobile station may be used to implement a personal alarm system. In FIG. 3, mobile station 301 comprises the components illustrated by FIG. 2 for mobile station 200, such that mobile station 301 may interrogate and receive information from a transponder tag.

The mobile station 301 may interrogate a set of transponder tags using air interface 303. In FIG. 3, a set of personal items may have transponder tags, for example; a briefcase 305, wallet 307, suit case 309, or other items such as a key chain. The mobile station 301 may in some embodiments have a priori knowledge of the transponder information contained by a set of tags. In that case, mobile station 301 may have the known transponder tag information stored in file storage 211 of memory 205. An alarm application residing in applications 209 will have a timing setting, which in some embodiments may be a user settable preference, such that the mobile station 301 will perform an transponder interrogation automatically at set time intervals using transponder interrogator 219. The mobile station transponder interrogator 219 may use a singulation protocol so as to check each of the tagged items without encountering problems with conflicting tag responses.

Alternatively, the mobile station 301 may attempt to generally interrogate the tags and use a tree walking protocol to determine either the number of tags present or to determine the information from each item for comparison to the previously stored information.

If the alarm application determines that one of the tagged items is not present, the mobile station 301 may provide an audible alarm to the user to indicate a possible loss or theft. In some embodiments the mobile station may automatically connect to a security system server 311 and provide the server 311 with the tag information of the missing item. If the mobile station user is within a building that has an appropriate transponder security system, which may be connected to an in-building network 313, the building may have transponder interrogators posted at various strategic locations including but not limited to the building exits. In such embodiments, the mobile station 301 may use network 313 and wireless interface 315 to inform the security server 311 of a missing item. The transponder interrogation system may monitor for a tag having the noted information such that a potential thief may be intercepted prior to leaving an area.

The alarm application may, in some embodiments, comprise a menu for configuration by the mobile station 301 user. For example, “Secured Item Descriptions” menu 317, may have various item fields, Item 1 321, Item 2 323, and Item 3 325, etc. The mobile station user may select one of the fields using selection cursor 319 and may enter description data for the particular field. For example, Item 1 321 may contain description information for the brief case 305.

One skilled in the art would recognize that systems in accordance with embodiments of the present invention could be beneficially used in airports, corporate campuses, university campuses, government buildings, etc. and could provide security for personal property as well as business, government or other property that is temporarily physically located within the confines of some definable geographic location.

Another application of the embodiment illustrated by FIG. 3 is a luggage locating capability. For example, in a crowded airport where a user is waiting for a luggage conveyer to dispense the user's particular items or item, such as suit case 309, other travelers may have identical luggage pieces making finding suitcase 309 a tedious task. By using an embodiment of the present invention, the user of mobile station 301 may activate transponder interrogator 219 while in proximity of a familiar looking luggage item and determine whether it is in fact suit case 309, by receiving an audible or visual indication from the mobile station 301 display. Other applications in accordance with embodiments of the present invention are easily conceivable by one or ordinary skill in the art.

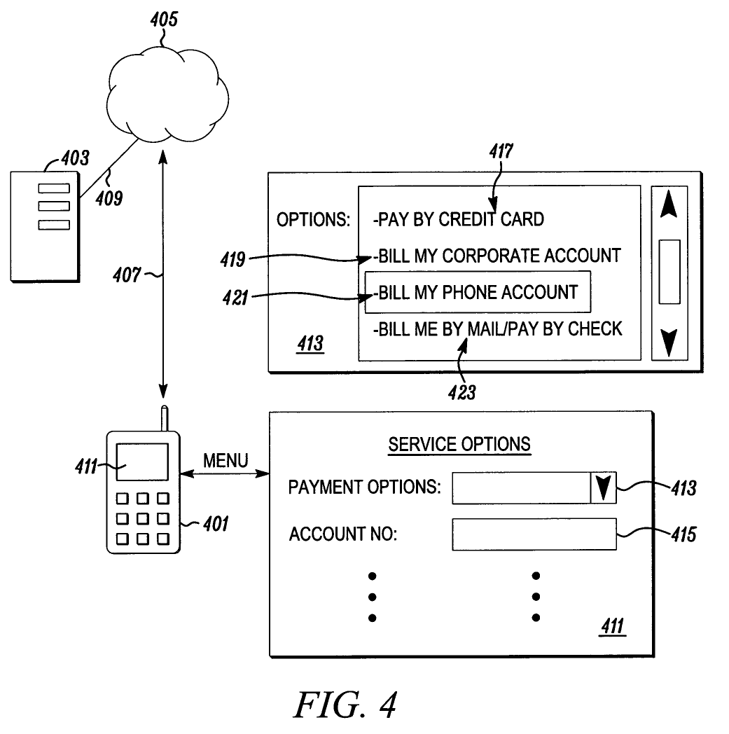

FIG. 4 illustrates an exemplary menu format of some embodiments of the present invention, in which the security service charges a usage fee at the particular service location. For example, in FIG. 4 mobile station 401 may access the security server 403 using wireless network 405 and wireless interface 407. The security server 403 is connected to the wireless network 405 by a connection 409, which may be any suitable connection and use any suitable protocol such as Ethernet, IP, etc.

The mobile station 401 may display a menu 411, which may be a user interface applet provided by security server 403 over network connections 409 and 407 through wireless network 405. The menu 411 may be for example a “service options” menu that allows the user to select payment options via a payment options sub-menu 413 or enter an existing account number via an account number field 415. The payment options sub-menu 413 may be a scrollable sub-menu and provide payment options such as; “Pay by credit card” 417, “Bill my corporate account” 419, “Bill my phone account” 421, “Bill me by mail/pay by check” 423. The security server 403 will have appropriate communications with the mobile station 401 service provider as required to enable the interchange of billing information required to enable services.

It is to be understood that the menu illustrated by FIG. 4 is for exemplary purposes only and that many possible menu configurations are conceivable, and that any such conceivable menu configurations would remain within the scope of the various embodiments of the present invention. After the user enables the payment options the security server 403 may receive, in some embodiments of the present invention, the alarm information generated by the mobile station 401 alarm application.

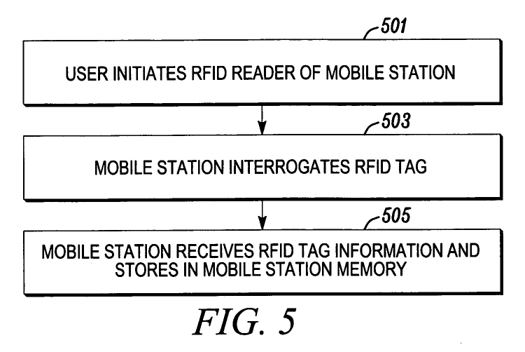

FIG. 5 is a flow diagram illustrating an initial configuration operation of embodiments of the present invention. FIG. 5 is best understood with reference to FIG. 3. In block 501, the mobile station 301 user may initiate interrogation of one or more transponder tags, such as the transponder tags associated with brief case 305, wallet 307, and suit case 309. The mobile station 301 interrogated the tag in block 503, and stores the tag information in memory in block 505. The mobile station 301 user may add additional descriptive information using Secured Item Descriptions menu 317 in some embodiments.

The transponder tags associated with the items may be associated in a variety of ways. In one embodiment, the tags may be installed by the item manufacturer for the purpose of security applications. The mobile station 301 user may then make use of the tags by scanning the tag information to mobile station 301 memory as illustrated by the procedure of FIG. 5. In other embodiments, the tags may be provided individually and concealed within the items, such as brief case 305, wallet 307, and suit case 309, by the owner of the items. The tag information may be scanned into the mobile station 301 memory in the same manner illustrated by FIG. 5.

The tag information may be specific to the items, or it may be generic information that is associated with the items by the user, by entering the appropriate association information into memory using Secured Item Descriptions menu 317 for example. It is to be understood that each individual tag information should in some way be unique, such that each tag can uniquely identify the item to which it is associated.

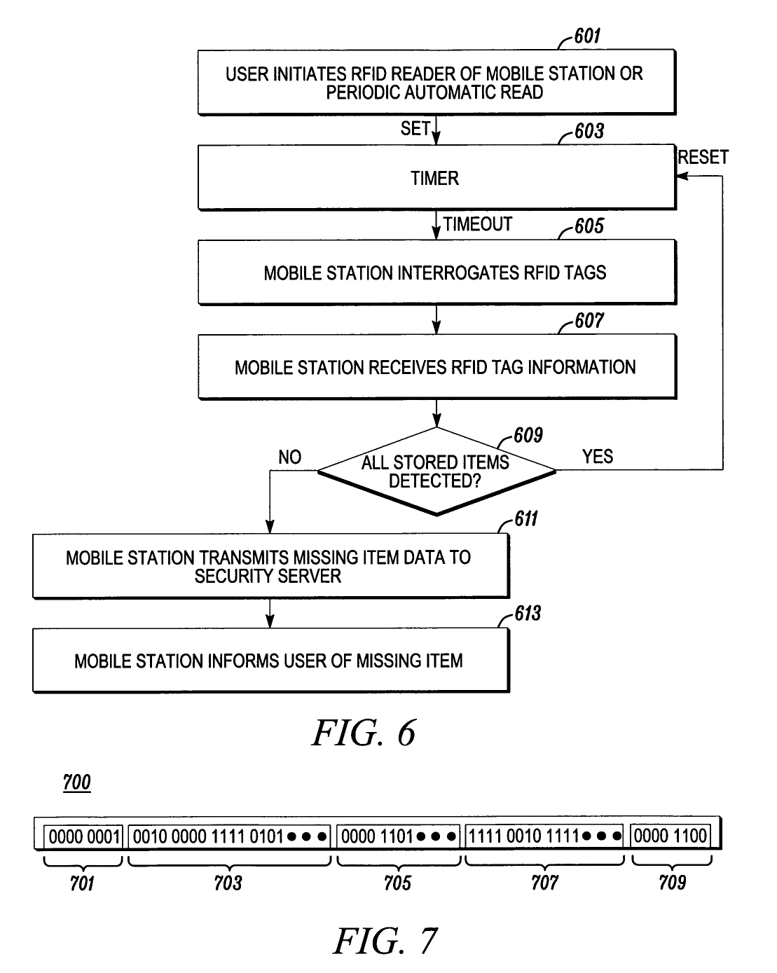

FIG. 6 is a flow diagram illustrating the basic operation of embodiments of the present invention. In block 601, the user may initiate an alarm application which performs a periodic automatic reading of transponder tags. Block 603 represents a timer which may have an interval configurable by a user, or a default setting optimized for minimal power consumption by the mobile station battery. Upon timeout, the mobile station interrogates the transponder tags in block 605. The interrogation may use a singulation protocol based upon the previously entered tag information per the procedure illustrated in FIG. 5. In other embodiments, a tree walking protocol may be employed.

In block 607, the mobile station receives the tag information and in block 609 compares it with the previously stored information. If all items listed in memory are present, timer 603 is reset and the procedure continues If one or more of the items is not detected, the mobile station in some embodiments will transmit a notification message to a security server as shown in block 611. In the embodiments in which a security server is employed, security staff may subsequently be notified by wireless means, such as 802.11 capable mobile stations, that an item is missing. The description of the item may also be provided. Transponder readers located at various strategic locations may also be notified by the security server and begin to scan for the item or items.

The mobile station will also inform the mobile station user of the missing item as shown in block 613. The user notification may be any suitable indication such as an audible alarm, vibration, or visual indication, or a combination of indicators. The user may configure the type of notification using a configuration interface of the application.

It is to be understood that block 611 is not required in all embodiments of the present invention and that in some embodiments block 611 will be omitted. For example, in areas where no security system is available, the mobile station user may rely upon the mobile station alarm indication only as illustrated by block 613.

FIG. 7 illustrates further details of transponder tag information in accordance with some embodiments of the present invention. In FIG. 7, the transponder tag information 700 is represented as a series of bit fields. The bit fields in some embodiments may conform to standards applicable to an Electronic Product Code (EPC). For example, a first bit field 701 may be a header or flag and contain 8 bits. The second bit field 703 may conform to the EPC manager field and contain 28 bits. The third bit field 705 may be designated as an object class field and contain 24 bits. The fourth bit field 707 may be a serial number field and contain 36 bits. Additionally, an optional bit field 709 may provide a check digit, which may be 8 bits in length, for the purpose of verification of the transponder tag information transfer. For example, the bit fields 701, 703, 705, and 707 may when input into a checking algorithm produce the check digit provided by bit field 709. The checking algorithm may be executed by mobile station processor 203 as a mobile station application 209 stored in mobile station memory 205.

It is to be understood that the bit fields illustrated by FIG. 7 are exemplary only and that any segregation of bit fields is possible and that any such bit segregations would remain in accordance with the embodiments of the present invention. Further, the embodiments of the present invention may use various overall bit lengths such as, but not limited to 96 bits, 256 bits, 512 bits or greater and that the segregation of bit fields may be made in any manner appropriate for a particular application and would remain in accordance with the embodiments of the present invention. Further, although certain transponder tag bit length storage may be standardized by the transponder tag industry, bit lengths of less than 96 bits, in which a 96 bit length is generally made use of by Electronic Product Codes (EPCs) for example, may be used and remain in accordance with the embodiments of the present invention. Further, in some embodiments of the present invention, various bit fields of transponder tag information 700 may be used in various ways.

It is to be understood that other services and business models are conceivable using the various embodiments of the present invention and that while several such embodiments have been disclosed herein, such embodiments are not a limitation on other similar embodiments that may be conceived that would remain in accordance with the present invention. For example, a user may carry a tag on his or her person which could also be periodically scanned by the mobile station. In this case, the mobile station may provide an audible alarm when the mobile station does not detect the tag, for the purpose of avoiding losing the mobile station itself.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a mobile station comprising:
receiving data from a at least one transponder;
comparing the data to a list of items stored in memory; and
determining whether an identifier has been received for each item in the list of items stored in memory.

2. The method of claim 1, further comprising:
providing an indication if an identifier has not been received for each item in the list of items stored in memory.

3. The method of claim 2, further comprising:
transmitting a second indication to a server.

4. The method of claim 2 wherein the step of comparing the data to a list of items stored in memory further comprises:
decoding at least one bit field of the data to determine at least one decoded bit field information; and
comparing the at least one decoded bit field information to at least one bit field information stored in memory.

5. A mobile station comprising:
at least one wireless transceiver;
a transponder reader integrated with a data decoder;
a memory;
at least one processor connected to the at least one wireless transceiver, to the memory, and to the transponder reader and configured to:
receive data from a at least one transponder;
compare the data to a list of items stored in the memory; and
determine whether an identifier has been received for each item in the list of items stored in memory.

6. The mobile station of claim 5 wherein the at least one processor is further configured to provide an indication if an identifier has not been received for each item in the list of items stored in memory.

7. The mobile station of claim 6 wherein the at least one processor is further configured to transmit a second indication to a server using the at least one wireless transceiver.

8. The mobile station of claim 7 wherein the at least on processor is further configured to:
decode at least one bit field of the data to determine at least one decoded bit field information; and
compare the at least one decoded bit field information to at least one bit field information stored in memory.
